(19) United States
(12) Patent Application Publication
(10) Pub. No.: US 2001/0036267 A1
(43) Pub. Date: Nov. 1, 2001

(54) Method for generating electronic keys from integer numbers prime with each other and a device for implementing the method

(76) Inventor: Pascal Paillier, Paris (FR)

Correspondence Address: BURNS DOANE SWECKER & MATHIS L L P, POST OFFICE BOX 1404, ALEXANDRIA, VA, 22313-1404, US

(21) Appl. No.: 09/818,658

(22) Filed: Mar. 28, 2001

(30) Foreign Application Priority Data
Mar. 28, 2000 (FR) 00/03919

(51) Int. Cl. H04L 9/00

(52) U.S. Cl. 380/44

(57) ABSTRACT

A method for generating electronic keys from two integer numbers a, b, includes the step of verifying that the numbers are prime relative to each other. This verification step comprises the operations of calculating the modular exponentiation a^{λ(b)}modb, where λ is the Carmichael function, verifying that this modular exponentiation is equal to 1, storing the pair a, b when equality is verified, and reiterating the procedure with another pair when there is no verification. The invention applies to chip cards with a microprocessor having an arithmetic processor.

This disclosure is based upon, and claims priority from, French Application No. 00/03919, filed Mar. 28, 2000, the contents of which are incorporated herein by reference.

### BACKGROUND OF THE INVENTION

The invention relates to a method for generating electronic keys from integer numbers that are prime with each other, and a device for implementing the method.

The invention applies particularly to public key cryptography protocols used for the encoding of information and/or authentication between two entities and/or the electronic signature of messages. It applies in particular to public key cryptography protocols such as the RSA (Rivest, Shamir and Adelman), El Gamal, Schnorr or Fiat Shamir protocols.

In the case of such applications use is in fact made of the generation of large integer numbers (which may for example be greater than or equal to 512 bits) in order to form one or more keys of the protocol. One condition is imposed for choosing these numbers so that they remain secret, namely that they must be co-prime or prime with each other.

In practical terms, an electronic device which wishes to generate such numbers with a view for example to implementing a cryptography protocol operates in a known manner in the following way:

Select an integer number a (chosen from amongst a set of predetermined integer numbers, or drawn randomly),

Randomly draw a second integer number b,

Perform an operation of verifying that the co-primeness between the numbers a and b are co-prime. This operation makes it possible to verify that the two integer numbers a, b are prime with each other. It is performed by the central unit of the device. The central unit calculates for this purpose the highest common factor (HCF) between these two numbers and verifies that the result is equal to 1. This is because it will be recalled that two numbers are co-prime if and only if, their highest common factor is 1.

There exist several well-known techniques of implementing the calculation of the HCF of two numbers by means of a microprocessor. By way of example there are the techniques such as those of “Binary GCD”, the “Extended GCD” or the Lehmer technique. In spite of an excellent asymptotic complexity (that is to say for numbers of an extremely large size), these techniques prove both to be difficult to program on portable devices of the microprocessor card type (since they are complex) and to have mediocre performance for numbers with normal large sizes (512 bits), which are tending at the present time to become higher, namely 1024 bits and more.

### SUMMARY OF THE INVENTION

The aim of the invention is to remedy this drawback. Its object is more particularly a method for generating electronic keys from two integers a, b, the method comprising a step of verifying the co-primeness of the numbers a, b, wherein this verification step comprises the following operations:

A) calculating the modular exponentiation a^{λ(b)}modb, where λ is the Carmichael function,

B) verifying that this modular exponentiation is equal to 1,

and wherein:

C) the pair a, b is retained when equality is verified and reiteration is carried out with another pair in the contrary case.

According to another characteristic:

an integer number b with a given length is chosen and is stored in memory,

an integer number a is drawn at random,

a^{λ(b)}modb is calculated,

it is verified that a^{λ(b)}=1 modb (or a^{λ(b)}modb=1),

the number a is stored in memory in the case where equality is verified,

the above steps are reiterated with another number a in the contrary case.

According to another characteristic, where the number b is given in advance, the value λ(b) is calculated in advance and stored in memory.

The invention applies to the methods of generating RSA or El Gamal or Schnorr cryptographic keys.

Another object of the invention is a portable electronic device comprising an arithmetic processor and an associated program memory, able to effect modular exponentiations, which device comprises a program for verifying the co-primeness of integer numbers of given length, which performs the following operations:

A) calculating the modular exponentiation a^{λ(b)} modb, where λ is the Carmichael function,

B) verifying that this modular exponentiation is equal to 1,

and wherein:

C) the arithmetic processor stores the pair a, b when equality is verified and reiterates with another pair in the contrary case.

According to another characteristic, where the number b is given in advance, the value λ(b) is calculated in advance and is stored in memory.

Advantageously the portable electronic device consists of a chip card with microprocessor, e.g. a smart card.

### BRIEF DESCRIPTION OF THE DRAWINGS

Other particularities and advantages of the invention will emerge clearly from a reading of the description made below, which is given by way of non-limitative example with regard to the accompanying drawings, in which:

FIG. 1 depicts a block diagram of a portable electronic device such as a chip card implementing the method according to the invention, and

FIG. 2 is a flow diagram of an example embodiment of the implementation of the method according to the invention.

### DETAILED DESCRIPTION

In the following description, smart cards with a microprocessor are described as an example of a portable electronic device in which the present invention can be implemented. It will be appreciated, however, that the invention is applicable to all types of portable electronic devices, and hence this exemplary embodiment should not be construed as being limiting in any fashion.

In the case of the implementation of cryptography protocols such as the RSA, for example, it is necessary to determine a pair of integer numbers of given length, that are prime with each other, to be used for generating electronic keys of the protocol. In order to ensure that the selected numbers are prime with each other, a step of verifying co-primeness is performed by the microprocessor card, which uses the method for generating keys for the cryptography protocol.

In practice, in the RSA protocol, the two integer numbers a, b remain secret, they must be prime with each other and have a fixed length, generally each 512 bits or 1024 bits. According to this same example, one of the two numbers, b, is an integer number chosen in advance and stored amongst a set of numbers generated by the microprocessor card, whilst the other number, a, is generated in a random fashion by the microprocessor card when the protocol is executed. To this end, the microprocessor card has a random number generator, capable of supplying an integer number of the required size.

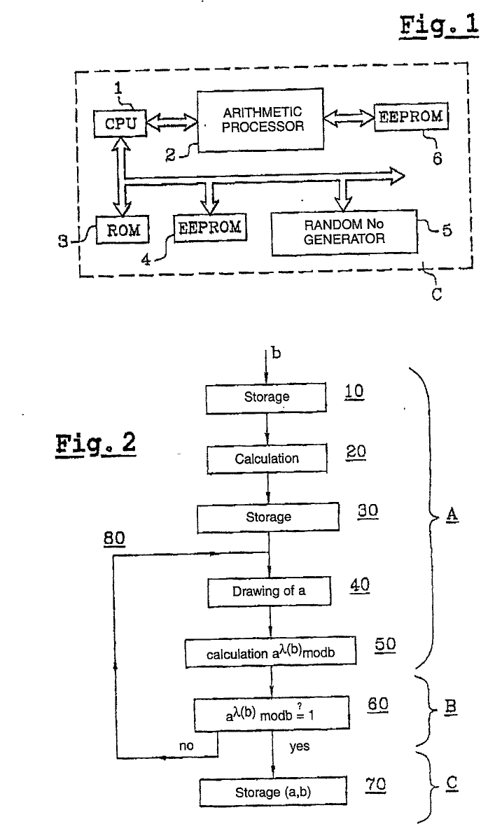

FIG. 1 shows the functional diagram of a microprocessor card that is able to implement the method according to the invention. The card C has a main processing unit 1, program memories 3 and 4 and a working memory (not shown), associated with the central processing unit 1. The card also has an arithmetic processor 2 capable of performing modular exponentiation calculations. For example, it could be a unit such as the circuit ST16CF54 sold by STMicroelectronics or 83C852/5 from Philips. The card also has a random integer number generator 5.

According to the invention, the operation of verifying the co-primeness of the integer numbers a and b is performed by steps A and B indicated in the diagram in FIG. 2, with the step of retaining the pair a, b in order to generate an electronic key in the case where these numbers are prime with each other. In practice this step consists of storing the pair a, b in the protected memory 6 (not accessible from outside) of the arithmetic processor 2.

Before describing an example of an implementation of the method according to the invention in the case of the RSA protocol, it should be stated that the function λ is the Carmichael function and that this function is defined by the following equation:

λ(b)=LCM(λ(p^{δ1}), . . . , (λ(p^{δk}),

in which LCM designates the lowest common multiple,

in which b=πpᵢ^{δk} iAK where each pi is a prime number and each δi a non-zero positive integer and 1<i<k.

In the example illustrated of the RSA cryptography protocol, the following steps are carried out:

storing the chosen integer number b of fixed given length, step (10)

calculating λ(b), step (20)

storing the number λ(b), step (30)

These steps can be preliminary to the steps which follow in so far as b is known in advance. In this case the precalculated value λ(b) will be stored in the protected memory 6 of the arithmetic processor 5. The process then continues with the following steps:

drawing a random integer number a, step (40)

calculating a^{λ(b)}modb, step (50)

comparing a a^{λ(b)}modb with 1, step (60)

if there is equality, storing the pair (a, b) in order to generate a key of the cryptography protocol, step (70)

if there is no equality, reiterating the previous steps as from the drawing of an new integer number a, loop (80).

Once the co-primeness of the numbers has been verified, they are then employed as keys to encrypt and decrypt information with a public key cryptography protocol, such as RSA, El Gamal, Schnorr or Fiat Shamir.

It will be appreciated by those of ordinary skill in the art that the present invention can be embodied in other specific forms without departing from the spirit or essential characteristics thereof. The presently disclosed embodiments are therefore considered in all respects to be illustrative, and not restrictive. The scope of the invention is indicated by the appended claims, rather than the foregoing description, and all changes that come within the meaning and range of equivalence thereof are intended to be embraced therein.

What is claimed is:

1. A method for generating electronic keys from two integers a, b, the method comprising a step of verifying the co-primeness of said numbers a, b, which includes the following operations:
A) calculating the modular exponentiation a^{λ(b)}modb, where λ is the Carmichael function,
B) verifying that this modular exponentiation is equal to 1,
C) retaining the pair a, b when equality is verified, and
D) reiterating operations A and B with another pair of numbers when the modular expansion is not equal to 1.

2. A method for generating electronic keys according to claim 1, wherein:
an integer number b with a given length is chosen and is stored in memory,
an integer number a is drawn at random,
a ^{λ(b)}modb is calculated,
it is verified that a^{λ(b)}=1 modb (or a ^{λ(b)}modb=1),
the number a is stored in memory in the case where equality is verified,
the above steps are reiterated with another number a when equality is not verified.

3. A method for generating electronic keys according to claim 1, wherein the number b is predetermined, and the value λ(b) is calculated in advance and stored in memory.

4. The method of claim 1 further including the steps of encrypting and/or decrypting information by means of a public key cryptography protocol, using said integers as the encryption and decryption keys.

5. A method for generating RSA or El Gamal or Schnorr cryptographic keys, comprising the steps of:
A) selecting two integers a, b as candidates for the keys;
B) calculating the modular exponentiation a^{λ(b)}modb, where λ is the Carmichael function,
C) verifying that this modular exponentiation is equal to 1,
D) retaining the pair a, b when equality is verified, and
E) reiterating steps B and C with another pair of numbers when the modular expansion is not equal to 1.

6. A portable electronic device comprising an arithmetic processor and an associated program memory that are capable of effecting modular exponentiations, and further including a program for verifying the co-primeness of integer numbers of given length, which performs the following operations:
A) calculating the modular exponentiation a^{λ(b)}modb, where λ is the Carmichael function,
B) verifying that this modular exponentiation is equal to 1,
C) storing the pair a, b in the arithmetic processor when equality is verified, and
D) reiterating steps A and B with another pair of integers when equality is not verified.

7. A portable electronic device according to claim 6, wherein the number b is predetermined and the value λ(b) is calculated in advance and stored in a memory.

8. A portable electronic device according to claim 6, wherein said portable electronic device comprises a chip card with a microprocessor.
